(19) United States
(12) Patent Application Publication
(10) Pub. No.: US 2003/0218965 A1
(43) Pub. Date: Nov. 27, 2003

(54) High-density information storage media

(76) Inventors: Jau-Jiu Ju, Hsinchu Hsien (TW); Hai-Hsiang Tsai, Hsinchu Hsien (TW); Tzuan-Ren Jeng, Hsinchu Hsien (TW); Der-Ray Huang, Hsinchu Hsien (TW)

Correspondence Address: BIRCH STEWART KOLASCH & BIRCH, PO BOX 747, FALLS CHURCH, VA, 22040-0747, US

(21) Appl. No.: 10/263,188

(22) Filed: Oct. 3, 2002

(30) Foreign Application Priority Data
May 21, 2002 (TW) 91110592

(51) Int. Cl. G11B 7/24

(52) U.S. Cl. 369/275.4; 369/283; 369/94

(57) ABSTRACT

A high-density information storage medium has a shorter length of information bits and a smaller pitch of track. The storage capacity is increased by shortening the track pitch and data bit length and increasing the storage density. The medium of the invention can be made by current CD manufacturing facilities, and can be read through general DVD devices.

### BACKGROUND OF THE INVENTION

1. Field of the Invention

The invention generally relates to a high-density information storage medium, and particularly relates to an information storage medium that has a shorter length of information bits and a smaller pitch of track.

2. Related Art

As the era of information and multi-media comes, the needs for high density and high volume storage media in triple-C (computer, communication and consumer electronics) products are increasing. Among the optical information storage media, the compact disc (CD) standard published by Philips and Sony in 1982 has been widely adopted and used today.

The requirements of high density and high volume storage media for multi-media applications today are getting higher and higher that prior CDs cannot meet. Though a popular video compact disc (VCD) can store video image, it is short in poorer video quality than video tape and low capacity of only one hour length of video that cannot afford a general film that has a length of at least 90 minutes. This makes video storage using more discs and inconvenience in changing the discs when viewing.

In order to improve the video quality and storage capacity, Philips, Sony and other manufacturers proposed the DVD (digital versatile disc) standard in April, 1996. For storing digital information, A DVD can afford 4.7 gigabytes that is much higher than the 650 megabytes of a compact disc. A DVD not only provides high quality sound and images but also has the capability of storing a video of approximately 133 minutes. Therefore, devices for reading and playing DVDs become the mainstream products in the consumer market. Variant DVD specifications have also been developed. In U.S. Pat. No. 5,777,981 owned by Toshiba, the track pitch of a DVD is set within the range of (0.72 to 0.8) times (λ/NA)/1.4 micrometer. When the wavelength of the light beam is 650 nanometer and the numerical aperture NA of the objective lens is 0.6, the track pitch is from 0.68 to 0.76 micrometer. This range just covers the wavelength 0.74 micrometer listed in the DVD specifications published by the DVD Forum (an international organization composed of hardware manufacturers for developing DVD-RW, DVD-R and DVD-RAM).

However, as the current video techniques being improved by high-definition television (HDTV) for the sake of higher video quality, the HDTV is becoming a new standard for high quality sound and image of video signal. The HDTV supports 1,920 times 1,080 resolution, 16:9 screen proportion and a higher refreshing frequency of 30 or 60 frames per second (while the current video frequency is only 24 or 30 frames per second). For the requirements of HDTV, the storage capacity of current 4.7 gigabyte DVD is further a bottleneck. A DVD media will now store only less than 40 minutes of HDTV signal. Therefore, the current DVD media cannot fulfill the need of HDTV video storage.

### SUMMARY OF THE INVENTION

The object of the invention is to provide a high-density information storage medium that increases its storage capacity. In order to increase the storage capacity, the medium segment representing a bit of information on the storage medium has to be shrunk. The invention increases the storage capacity by shortening the track pitch and data bit length and increasing the storage density.

A high-density information storage medium according to the invention includes a substrate having information recorded by a plurality of pit trains formed thereon at a specified track pitch. The track pitch is set within the range of 0.61 to 0.67 micrometer. The minimum length of the signal pit is from 0.28 to 0.47 micrometer. An optimal track pitch according to the invention is 0.64 micrometer. If further applying high-efficiency recording techniques, Such as 8/15 modulation, the data bit length can further be shortened to 0.25 micrometer.

Conveniently, the high-density information storage medium of the invention can be made under the current CD fabrication process and facilities so as to lessen the cost influence. Also, the high-density information storage medium of the invention is compatible with current DVD hardware that prior DVD pickup heads can be used to read the information stored on the new medium. Therefore, it will not increase cost of new device to the customer. According to the invention, the storage capacity of a single-side single-layer disc medium is 5.4 gigabytes, and can be increased to 6 gigabytes if applying 8/15 modulation and high-efficiency error correction code (ECC) methods. When further applying the current multi-layer and double-side techniques, a single-side double-layer disc can store about 11 gigabytes; a double-side single-layer disc can store about 12 gigabytes; and a double-side double-layer disc can store about 22 gigabytes. If further applying information compression techniques, such as MPEG-4, the storage capacity can further be increased.

### BRIEF DESCRIPTION OF THE DRAWINGS

The invention will become more fully understood from the detailed description given here in below. However, this description is for purposes of illustration only, and thus is not limitative of the invention, wherein:

FIG. 1 is a descriptive view of a high-density information storage medium of the invention;

FIG. 2 is a descriptive view of track and pit segments in a high-density information storage medium of the invention;

FIG. 3A is a microscopic photograph of pit segments on a high-density information storage medium of the invention;

FIG. 3B is a microscopic photograph of pit segments on a general DVD medium;

FIG. 4 is an eye-pattern of a high-density information storage medium of the invention;

FIG. 5 is an eye-pattern of a general DVD medium;

FIG. 6A is an eye-pattern photograph of data read by a DVD pickup head for a high-density information storage medium of the invention;

FIG. 6B is an eye-pattern photograph of data read by a DVD pickup head for a general DVD medium; and

FIG. 7 is a comparative diagram on levels of radio frequency signals of a high-density information storage medium of the invention and a general DVD medium.

### DETAILED DESCRIPTION OF THE INVENTION

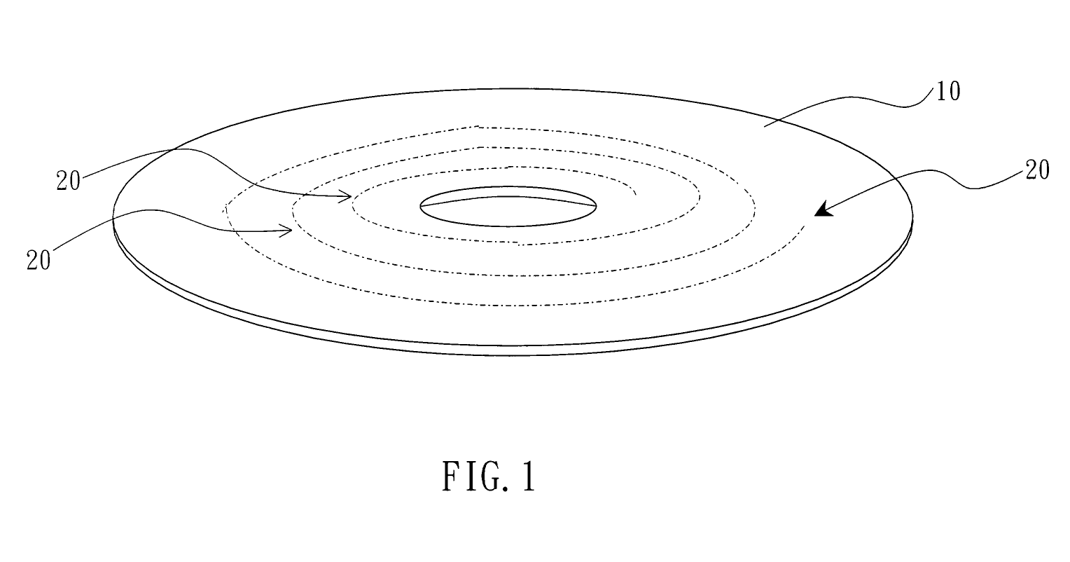

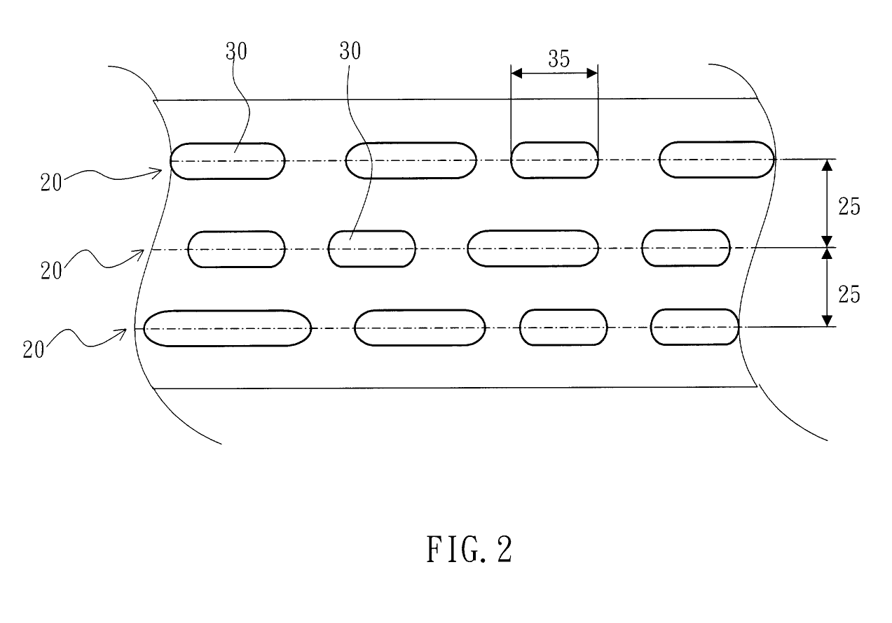

The invention provides an information storage medium having a higher storage density than a general DVD medium. A general DVD medium has a diameter of 120 millimeters and a storage capacity of 4.7 gigabytes for a single-side single-layer disc. The track pitch is 0.74 micrometer. The minimum pit length is 0.4 micrometer and the data bit length is 0.267 micrometer. The wavelength of the light beam of pickup head is 650 nanometer and the numerical aperture (NA) of the objective lens is 0.6. As shown in FIG. 1 and FIG. 2, a high-density information storage medium has a same configuration of diameter and thickness as a general DVD medium. The medium of the invention includes a substrate 10 having information recorded by a plurality of pit trains 20 formed thereon at a specified track pitch 25. The track pitch 25 is set around 0.64 micrometer. A minimum length 35 of the signal pit 30 is around 0.4 micrometer. By further applying high-efficiency recording techniques, such as 8/15 modulation, the data bit length can further be shortened to 0.25 micrometer. An error correction code can also be adopted.

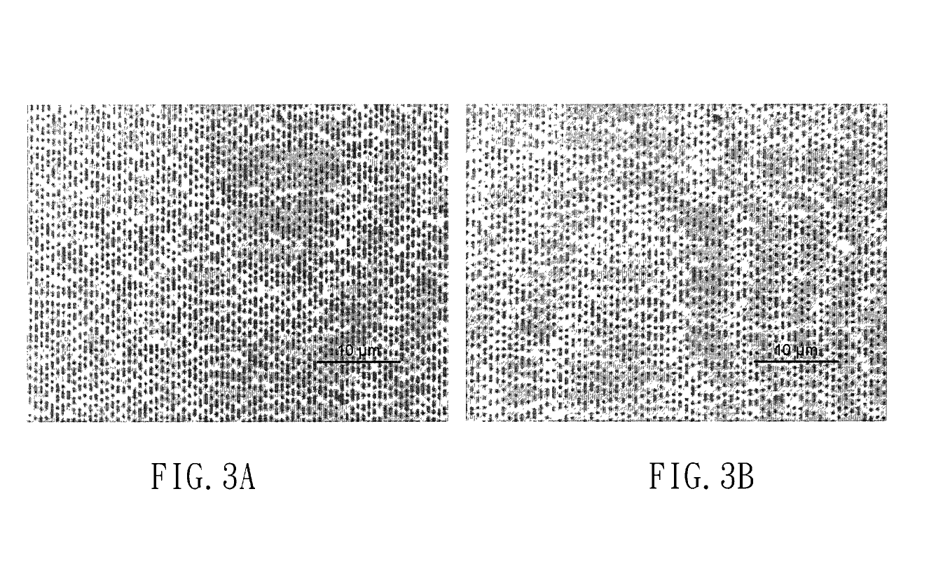

An embodiment of the invention is shown in FIG. 3A, which is a microscopic photograph of pit segments on a high-density information storage medium of the invention. In comparison with FIG. 3B, which is a microscopic photograph of pit segments on a general DVD medium, it is clear that the invention has a higher storage density than the general DVD medium.

The high-density information storage medium of the invention can be made under the current CD fabrication process and facilities so as to lessen the cost influence. Also, the high-density information storage medium of the invention is compatible with current DVD hardware that prior DVD pickup heads with 650 nanometer light beam and 0.6 numerical aperture can be used to read the information stored on the new medium. Therefore, it will not increase cost of new devices to the customers.

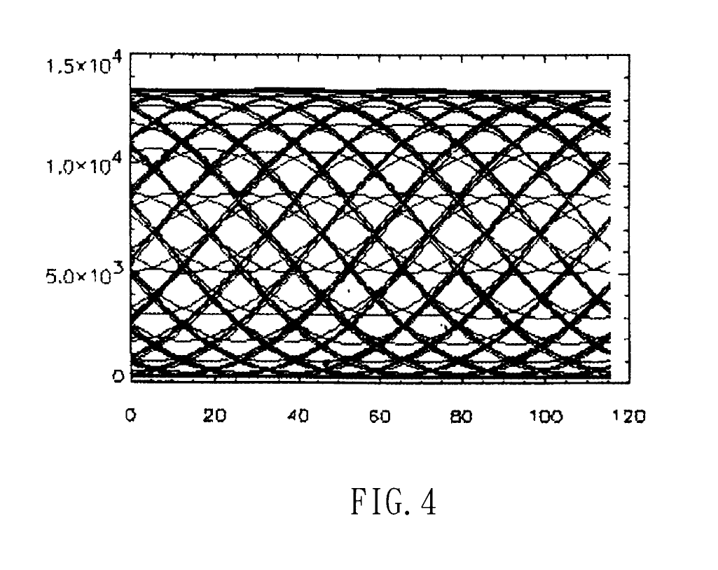

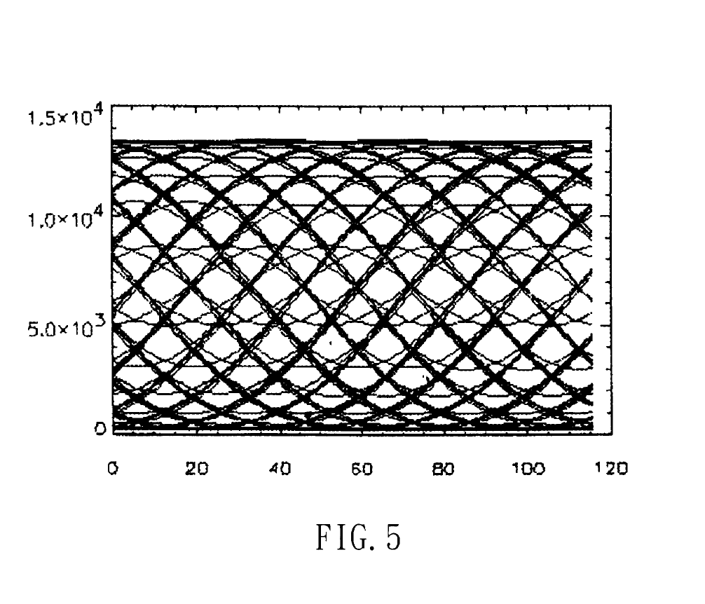

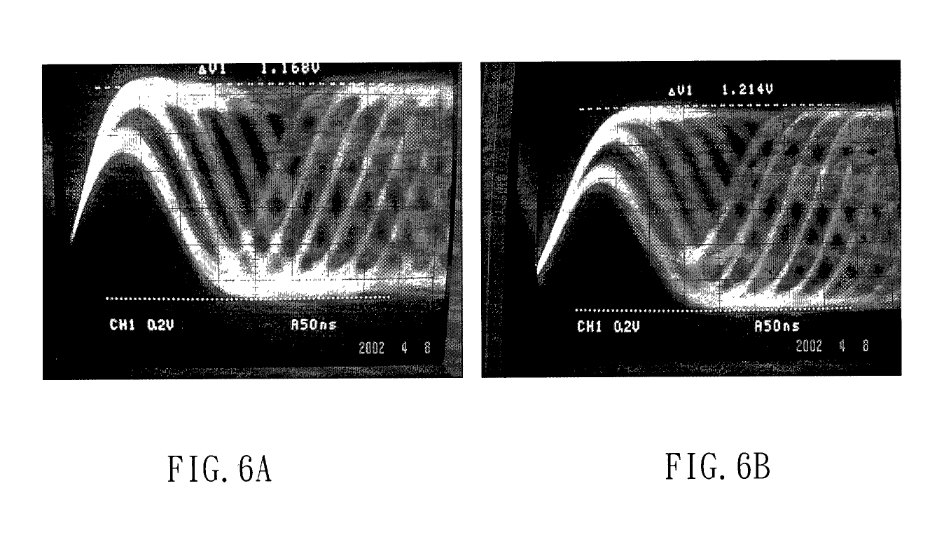

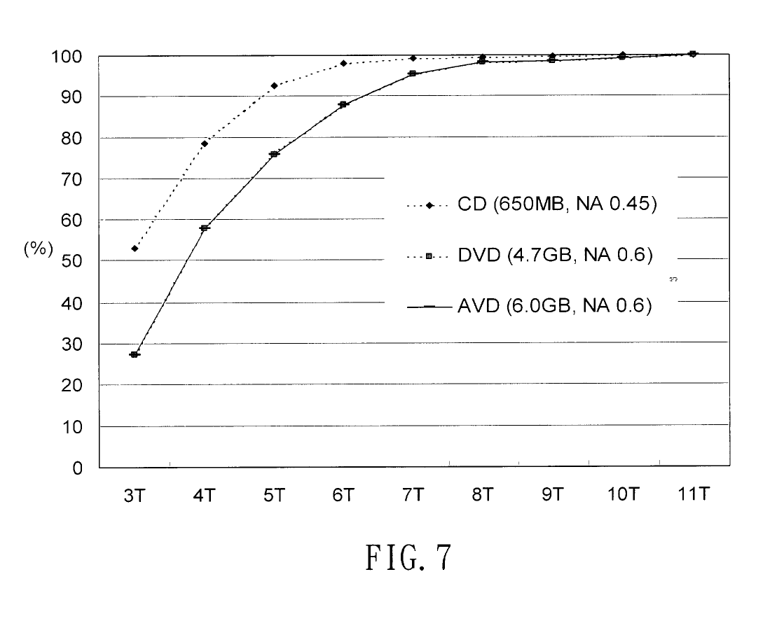

FIG. 4 is an eye-pattern of a high-density information storage medium of the invention. Eye-pattern is the received waveform of the read back signal from the disc. The horizontal axis is a time scale, while the vertical axis is the amplitude of read signal. The eye patterns are used by those skilled in the art to judge the quality of the read back signal. In comparison with FIG. 5, an eye-pattern of a general DVD medium, they have the similar patterns. Further comparing the photographs taken directly from oscilloscope for eye-patterns of a high-density information storage medium of the invention and a general DVD, as shown in FIGS. 6A and 6B, they show the similar patterns. Also, from FIG. 7, a comparison chart of radio-frequency (RF) signal levels among a compact disc, a general DVD and a high-density information storage medium of the invention, it is clear that the medium of the invention has a same RF signal level as the general DVD. By the aforesaid comparisons, it is sure that the signal qualities of the high-density information storage medium of the invention and the general DVD medium are comparable, and the high-density information storage medium of the invention can be read back with current DVD devices.

In practice, the track pith of a high-density information storage medium of the invention is set in a range of 0.61 to 0.67 micrometer. The minimum pit length is set in a range of 0.28 to 0.47 micrometer. The diameter of the medium is 80 or 120 millimeter with a variance less than 5%. By applying multi-layer and double-side techniques, the high-density information storage medium of the invention can also be made as a single-side multi-layer disc, a double-side single-layer disc or a double-side multi-layer disc.

In conclusion, the invention increases the storage capacity of an information storage medium by shortening the track pitch and data bit length and increasing the storage density. The medium of the invention can be made by current CD manufacturing facilities, and can be read through general DVD devices. By applying 8/15 modulation and high-efficiency error correction code (ECC) methods, the storage capacity of a single-side single-layer disc medium can be increased to 6 gigabytes. By further applying multi-layer and double-side techniques, a single-side double-layer disc can store about 11 gigabytes; a double-side single-layer disc can store about 12 gigabytes; and a double-side double-layer disc can store about 22 gigabytes. Table 1 lists the specifications and capacities of general DVD and single and multi-layer media of the invention for reference.

TABLE 1

| | | | High-density medium | | | |
|---|---|---|---|---|---|---|
| | General DVD | | of the invention | | | |
| | 1-side | 1-side | 1-side | 1-side | 2-side | 2-side |
| Parameters | 1-layer | 2-layer | 1-layer | 2-layer | 1-layer | 2-layer |
| Numerical | 0.6 | 0.6 | 0.6 | 0.6 | 0.6 | 0.6 |
| aperture | | | | | | |
| Beam | 650 | 650 | 650 | 650 | 650 | 650 |
| wavelength | | | | | | |
| (nm) | | | | | | |
| Track | 0.74 | 0.74 | 0.64 | 0.64 | 0.64 | 0.64 |
| pitch (μm) | | | | | | |
| Data | 0.267 | 0.293 | 0.250 | 0.275 | 0.250 | 0.275 |
| bit length (μm) | | | | | | |
| Minimum | 0.40 | 0.44 | 0.40 | 0.44 | 0.40 | 0.44 |
| pit length (μm) | | | | | | |
| Disc | 120 | 120 | 120 | 120 | 120 | 120 |
| Diameter (mm) | | | | | | |
| Substrate | 1.2 | 1.2 | 1.2 | 1.2 | 1.2 | 1.2 |
| thickness (mm) | | | | | | |
| Storage | 4.7 | 8.5 | 6.0 | 11.0 | 12.0 | 22.0 |
| capacity (GB) | | | | | | |

Furthermore, when applying information compression techniques, such as MPEG-4, the storage capacity for motion pictures can further be increased. Therefore, the high-density information storage medium is practical under current manufacturer facilities and customer devices. It is easy to be accepted by the manufacturers and customers.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A high-density information storage medium, comprising
a substrate having information recorded thereon; and
a plurality of pit trains formed on said substrate at a specified track pitch; said track pitch is set from 0.61 to 0.67 micrometer.

2. A high-density information storage medium according to claim 1 wherein said pit trains is formed with a plurality of pits each having a minimum length of 0.28 to 0.47 micrometer.

3. A high-density information storage medium according to claim 1 wherein said pit trains is formed with a plurality of pits each having an optimal minimum length of 0.4 micrometer.

4. A high-density information storage medium according to claim 1 wherein said track pitch is set at 0.64 micrometer.

5. A high-density information storage medium according to claim 1 wherein said medium having at least a recording layer.

6. A high-density information storage medium according to claim 1 wherein said medium utilizing 8/15 modulation to shorten the length of a data bit.

7. A high-density information storage medium according to claim 1 wherein said medium incorporating techniques of error correction code.

8. A high-density optical disc, comprising
a substrate having information recorded thereon; and
a plurality of pit trains formed on said substrate at a specified track pitch; said track pitch is set from 0.61 to 0.67 micrometer.

9. A high-density optical disc according to claim 8 wherein said pit trains is formed with a plurality of pits each having a minimum length of 0.28 to 0.47 micrometer.

10. A high-density optical disc according to claim 8 wherein said pit trains is formed with a plurality of pits each having an optimal minimum length of 0.4 micrometer.

11. A high-density optical disc according to claim 8 wherein said track pitch is set at 0.64 micrometer.

12. A high-density optical disc according to claim 8 wherein said disc having a diameter chosen from 80 and 120 millimeter and having a variance of diameter less than 5%.

13. A high-density optical disc according to claim 8 wherein said disc having a recording layer.

14. A high-density optical disc according to claim 8 wherein said disc having at least a recording layer and at least a reflecting layer so as to form a multi-layer optical disc.

15. A high-density optical disc according to claim 8 wherein said disc having at least a recording layer and at least a reflecting layer so as to form a double-side optical disc.

16. A high-density optical disc according to claim 8 wherein said disc utilizing 8/15 modulation to shorten the length of a data bit.

17. A high-density optical disc according to claim 8 wherein said disc incorporating techniques of error correction code.
